(19) United States
(12) Patent Application Publication
(10) Pub. No.: US 2011/0170862 A1
(43) Pub. Date: Jul. 14, 2011

(54) OPTICAL COMMUNICATIONS IN RECIPROCAL NETWORKS BASED ON WAVELENGTH SWITCHING

(76) Inventors: David F. Smith, Ellicott City, MD (US); Anis Husain, San Diego, CA (US); Sadik C. Esener, Solana Beach, CA (US)

(21) Appl. No.: 12/569,829

(22) Filed: Sep. 29, 2009

Related U.S. Application Data
(60) Provisional application No. 61/103,901, filed on Oct. 8, 2008.

(51) Int. Cl. H04B 10/08; H04J 14/00

(52) U.S. Cl. 398/26; 398/51

(57) ABSTRACT

Techniques, apparatus and systems to provide packet transmission in reciprocal transmission architecture networks for optical communications.

This application claims the priority of U.S. Provisional Patent Application No. 61/103,901 entitled “OPTICAL COMMUNICATIONS IN RECIPROCAL NETWORKS BASED ON WAVELENGTH SWITCHING” and filed Oct. 8, 2008, the entire contents of which are incorporated by reference as part of the specification of this application.

### FEDERALLY SPONSORED RESEARCH OR DEVELOPMENT

This invention was made with government support under Contract No. W911NF-07-0086 awarded by DARPA. The government has certain rights in the invention.

### BACKGROUND

This document relates to optical communication techniques, apparatus and systems.

Optical communications use light that is modulated to carry data or other information and can be used for a variety of applications. Examples include long-haul telecommunication systems on land or under the ocean to carry digitized signals over long distances. Optical communications are also used for connections to internet service providers or to carry cable television signals between field receivers and control facilities. Also, optical communications are used for signal distribution from telephone switching centers to distribution nodes in residential neighborhoods.

### SUMMARY

The techniques, apparatus and systems described in this document can be used to provide packet transmission in reciprocal transmission architecture networks for optical communications.

In one aspect, a system can include a first optical communication module to output a first optical signal, an optical link optically coupled to the first optical communication module to receive and transmit the first optical signal, and a second optical communication module optically coupled to the fiber to reflect the first optical signal, without changing an optical wavelength of the reflected light, back into the link towards the first optical communication module as a second optical signal to be received by the first optical communication module. The first optical communication module controls a wavelength of the first optical signal to change over time into, at a minimum, a first optical wavelength during a first duration of transmission of the first optical signal and a second, different optical wavelength during a second subsequent duration of the transmission of the first optical signal so that light being received in the second optical signal at the first optical communication module is at the first optical wavelength while light in the first optical signal being output by the first optical communication module is at the second optical wavelength. Optionally, the method can be implemented to modulate a data stream onto the reflected carrier signal at the station B.

In another aspect, a method which includes emitting a carrier signal from a station A. The emitted carrier signal is transmitted to a station B through an optical transmission line. The transmitted carrier signal is then reflected at the station B. The reflected carrier signal is transmitted back to the station A through the optical transmission line. The transmitted carrier signal is then received at the station A. Subsequently, the emission wavelength of the carrier signal is switched when the received carrier signal is at the emission wavelength.

In some implementations, the method can include emitting the carrier signal at a plurality of different wavelengths, one wavelength at a time. An emission time duration of each wavelength can be less than a round trip duration. Additionally, the emission time duration can be the same for each wavelength. Further, the carrier signal can have a 100% duty cycle. Furthermore, the plurality of different wavelengths can include at least three wavelengths. In addition, the plurality of different wavelengths can include at least five wavelengths.

In some implementations, an emission sequence for the plurality of different wavelengths can be preset. The method can also include emitting each of the plurality of wavelengths in order of increasing wavelength. When reaching the longest of the plurality of wavelengths, the method can be implemented to continue to emit each of the plurality of wavelengths in order of increasing wavelength starting with the shortest of the plurality of wavelengths. The method can further include emitting each of the plurality of wavelengths in order of decreasing wavelength. When reaching the shortest of the plurality of wavelengths, the method can be implemented to continue to emit each of the plurality of wavelengths in order of decreasing wavelength starting with the longest of the plurality of wavelengths. The plurality of wavelengths can include a continuous spectrum.

In some implementations, an emission sequence for the plurality of different wavelengths can be chosen randomly.

In yet another aspect, A system for transmitting a plurality of carrier signal packets from station A to station B and back to station A. The system includes an optical transmission line between station A and station B. The system also contains a transceiver coupled at station A. The transceiver includes a transmitter configured to emit the plurality of carrier signal packets for transmission to station B. The set of carrier signal packets is emitted at different wavelengths based on an emission schedule. The transceiver also includes a receiver configured to receive the plurality of carrier signal packets upon return to station A after reflection at station B. The receiver can reject a Rayleigh backscattering noise at an emission wavelength. The transceiver further includes a control unit configured to switch the emission wavelength upon receipt of a carrier signal packet at the emission wavelength. The system includes a reflector coupled at station B to direct the plurality of carrier signal packets back into the optical transmission line for return to station A.

In a further aspect, a method for transmitting a plurality of carrier signal packets from station A to station B and back to station A. The method includes providing an optical transmission line between station A and station B. A transmitter coupled at station A capable of emitting a plurality of carrier signal packets at a plurality of different wavelengths is integrated as part of the method. A receiver coupled at station A capable of selectively detecting the plurality of wavelengths emitted by the transmitter is also integrated into the method. A set of carrier signal packets is emitted at the plurality of different wavelengths according to an emission schedule such that a wavelength emitted by the transmitter is different from a wavelength of carrier signal packet detected by the receiver.

### BRIEF DESCRIPTION OF THE DRAWINGS

FIG. 1 shows a schematic of transmission in an optical communication link;

FIG. 2 shows a schematic of transmission in a reciprocal transmission architecture (RTA) link;

FIG. 3 shows relative magnitude of multiple loss sources for an RTA transmission link;

FIG. 4 shows another schematic of transmission in an RTA link system based on continuous wave (CW) carrier signals;

FIG. 5(a) shows examples of duty cycles for carrier signal emission;

FIG. 5(b) shows a method for emission of carrier signal packets for an RTA link system;

FIG. 5(c) shows transmission of a carrier signal packet in an RTA link system;

FIG. 6(a) shows a 100% duty cycle emission schedule including three 33% duty cycle signals;

FIG. 6(b) shows a method for emission of three carrier signal packets of different wavelengths in an RTA link system;

FIG. 6(c) shows transmission of three carrier signal packets of different wavelengths in an RTA link system;

FIG. 7 shows another transmission of three carrier signal packets of different wavelengths in an RTA link system;

FIG. 8(a) shows a station A of an RTA link system configured to operate according to a schedule based on n wavelengths;

FIG. 8(b) shows a method of operation for station A of an RTA link system;

FIG. 8(c) shows a three-wavelength schedule for emission and reception of carrier signal packets in an RTA link system;

FIG. 9(a) shows a station A of an RTA link system configured to operate according to another schedule based on n wavelengths;

FIG. 9(b) shows another method of operation for station A of an RTA link system;

FIG. 9(c) shows a five-wavelength schedule for emission and reception of carrier signal packets in an RTA link system;

FIG. 10 shows transmission of n carrier signal packets of different wavelengths in an RTA link system;

FIG. 11 shows the improvement in OSNR of RTA link systems operated using n carrier signal packets of different wavelengths with respect to RTA link systems operated using CW carrier signals.

### DETAILED DESCRIPTION

The techniques, apparatus and systems described in this document are based on reciprocal transmission architecture (RTA) of optical communication networks. In an RTA link system a carrier signal is sent from a sending station to a remote network station. The remote station modulates information onto the carrier and reflects the carrier back to the sending station along the same path. The techniques, apparatus and systems described in this document can be implemented in ways to enhance reception of the modulated carrier signal returning at the sending station against various effects that can adversely affect and complicate the reception and detection at the sending station.

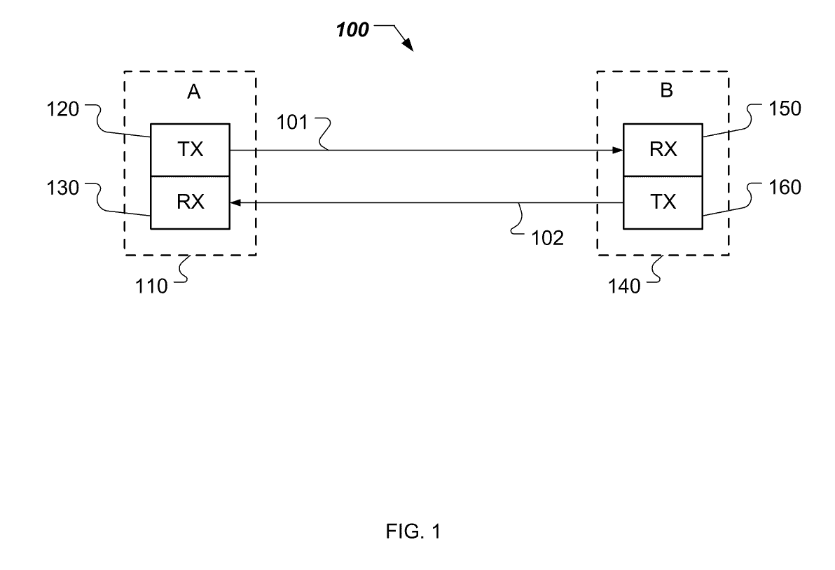

Most optical communication networks use fiber optic lines for transmission of optical signals between network nodes. An example of an optical communication link is illustrated schematically in FIG. 1 and includes two optical communication modules. Station A 110 has a transceiver that includes a transmitter TX 120 and a receiver RX 130. Station B 140 is in communication with station A 110 through optical transmission lines 101 and 102. Station B 140 also is equipped with a transmitter TX 160 and a receiver RX 150. The TX 120 at station A 110 encodes a data stream into a carrier signal and transmits a first encoded signal to station B 140 via the optical transmission line 101. The RX 150 at station B 140 receives the first encoded signal transmitted from station A 110. In response to the received encoded signal, the TX 160 at station B 140 encodes another data stream to another carrier signal and transmits a second encoded signal to station A 110 via the optical transmission line 102. The RX 130 at station A 110 receives the second encoded signal transmitted from station B 140. Thus, for the network link 100, bidirectional communication between stations A 110 and B 140 is accomplished through two transmission lines 101 and 102.

In the communication link 100 a sender of the first encoded signal does not know if the link is fully operational and optimized before the message is sent out. Furthermore, the sender at station A 110 does not know prior to sending the first encoded signal whether an intended recipient or an unauthorized recipient may receive at station B 140 the transmitted first encoded signal. Information on link integrity and security is important for various communication applications including mission critical real-time military applications.

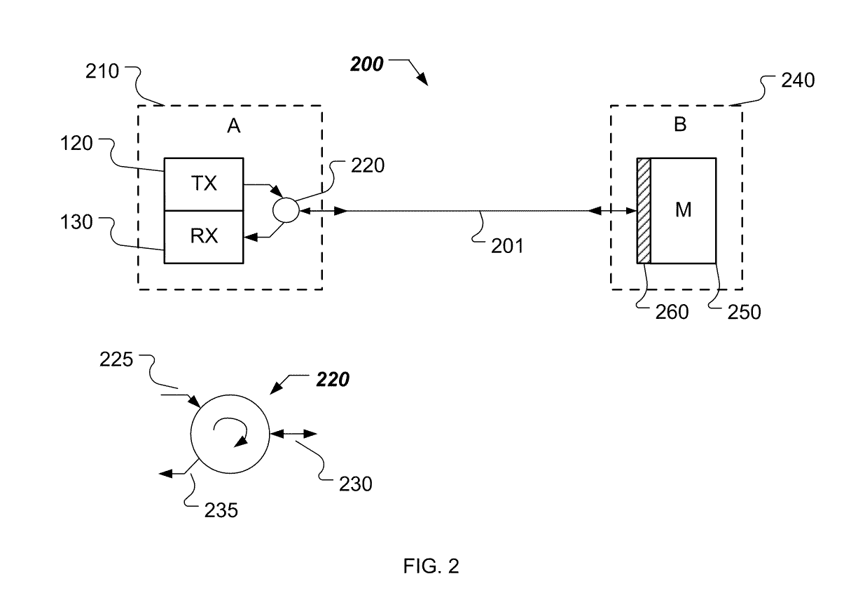

FIG. 2 shows an example of one direction of an RTA link system 200 which has two communication modules linked by a single optical path link that transmits light between two modules in the same path. This design can be configured to satisfy the signal integrity and security requirements enumerated above. Notably, the outgoing and return paths are identical or nearly identical, and thus station A may send out a known signal which is reflected in a prearranged manner by station B and returns to station A along the identical fiber path that it used for the upstream direction. Since station A knows exactly the transmitted signal, station A is uniquely positioned to infer and correct for network path degradations based on the returning signal.

The methods and systems disclosed in this document enable a user located at station A to determine if the RTA link system is fully operational and optimized before a first encoded signal is sent out from station B to station A, when an operator at station B applies an information bearing modulation to the reflected signal before it returns to station A. Furthermore, the operator at station A can determine that the transmission through the RTA link system has reached destination. Therefore, the operator at station A can optimize the signal for allowing station B to apply data and for ensuring error free performance when the optical carrier returns to station A. Disruptions can be instantaneously flagged to the operator of station A. Moreover, station B can now communicate with confidence through a controlled link since station B can infer from the presence of a carrier that station A is receiving a good signal. The RTA link architecture closes the loop of knowledge regarding the integrity of the link and provides both station A and station B with information regarding the link quality that neither node could achieve from other optical communications architectures.

As an example, the RTA link system in FIG. 2 can include a station A 210 that communicates with station B 240 through a transmission line 201. Station A 210 includes a transmitter TX 120, a receiver RX 130 and an optical coupler 220. The optical coupler 220 is a three-port element. The TX 120 is coupled to an input 225 of the optical coupler 220. The RX 130 is coupled to an output 235 of the optical coupler 220. The third terminal 230 of the optical coupler 220 is coupled to the optical transmission line 201. Terminal 230 of the optical coupler 220 represents an input-output port of station A 210.

Station B 240 includes a reflector 260 and a modulator 250. The reflector 260 is coupled to the optical transmission line 201 and represents the input-output port of station B. The reflector is also coupled to a modulator 250 which modulates the reflected light to superimpose information or data onto the reflected light.

FIG. 2 is one specific example of optical communication systems based on RTA design. Such systems include a first optical communication module to output a first optical signal, an optical link optically coupled to the first optical communication module to receive and transmit the first optical signal, and a second optical communication module optically coupled to the fiber to reflect the first optical signal, without changing an optical wavelength of the reflected light, back into the link towards the first optical communication module as a second optical signal to be received by the first optical communication module. The first optical communication module controls a wavelength of the first optical signal to change over time into, at a minimum, a first optical wavelength during a first duration of transmission of the first optical signal and a second, different optical wavelength during a second subsequent duration of the transmission of the first optical signal so that light being received in the second optical signal at the first optical communication module is at the first optical wavelength while light in the first optical signal being output by the first optical communication module is at the second optical wavelength.

Referring back to the specific example in FIG. 2, the operation of the RTA link system 200 is described below. A continuous wave (CW) carrier signal is emitted by the TX 120. The carrier signal emitted by the TX 102 is sent to the optical coupler 220 through the input 225. The carrier signal enters the optical transmission line 201 through the input-output port 230. The transmitted carrier signal reaches station B 240 where the light is reflected by the reflector 260 back into the transmission line 201. During the reflection process the modulator 250 can imprint a data stream onto the reflected light. The information encoded into the data stream includes the id of station B, id of an operator at station B, the power level of the received signal, etc.

The encoded carrier signal reflected by station B 240 travels through the transmission line 201 and returns to station A 210 through the input-output port 230 of the optical coupler 220. The returning signal is routed to the RX 130 via the output port 235 of the optical coupler 220.

The operator of station A 210 can now decode the information encoded in the returning carrier signal. Thus, with respect to transmission integrity, the verification of link establishment is at the physical level under full control of the sender at station A. The RTA link system 200 has characteristic properties which are known only to the system operator. Therefore, the RTA link system 200 can be used for applications where highly secure communications are needed.

The RTA link system 200 can be subject to various types of noise sources that can diminish the reception quality of the RX 130 at station A 210. To quantify the reception quality an optical signal-to-noise ratio (OSNR) is introduced. By definition the OSNR at a certain location is defined as the ratio of the average signal power <I_{S}> to the average noise power <I_{N}>, both detected at that location.

$$OSNR = \frac{〈 {I}_{S} 〉}{〈 {I}_{N} 〉} \qquad ( 1 )$$

For the RTA link system 200 it is of interest to evaluate the OSNR at the input-output port 230 of station A 210. A large value of OSNR at the input-output port 230 of station A 210 is obtained when the detected signal in the numerator is large, and the detected noise in the denominator is small. For the returning signal to be large, the losses in the transmission line have to be small. Also, for the detected noise to be small the contributions of the various types of noise have to be eliminated. If elimination of a noise source is not possible, the operator of the RTA link system 200 has to mitigate the effect of that noise.

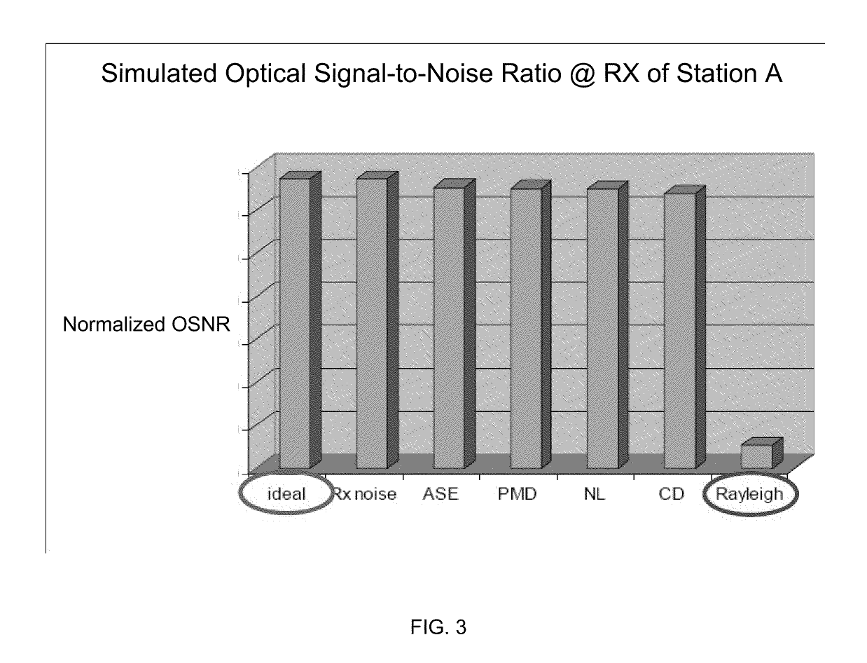

FIG. 3 illustrates a simulated signal OSNR at station A 210 for a 100 km long RTA link system 200. Several categories of noise occurring in an optical fiber based communication link, such as receiver noise, amplified spontaneous emission, polarization mode dispersion, fiber nonlinearities and chromatic dispersion are represented on the x-axis. The y-axis represents the OSNR corresponding to the noise categories represented in the x-axis. Each bar of the graph represents an OSNR calculated for one noise category at a time, according to EQ. 1. Moreover, the OSNR value for each noise category is normalized to the OSNR value of the first bar. The first bar represents an ideal link without losses.

Each type of noise occurring in the RTA link system 200 reduces the OSNR at the input-output port 230 of station A 210. FIG. 3 shows that the Rayleigh backscattering reduces the OSNR much more compared to the other categories of noise, showing that Rayleigh backscattering dominates performance in RTA link systems. Notably, Rayleigh backscattering is an optical noise source created by the upstream signal that co-propagates with the downstream returning signal at the same wavelength as the upstream signal. Further simulations show that the maximal reach of a simple bidirectional link subjected to Rayleigh backscatter is ˜50 km. At this distance the bit error rate (BER) rises to 10⁻³ which is the maximal BER that can be handled by most forward error correction (FEC) codes to achieve errorless transmission.

The following sections of this document describe how Rayleigh backscatter interacts with signals transmitted in RTA link systems. Rayleigh backscatter is an intrinsic property of light propagating in optical fibers. Therefore Rayleigh backscattering noise is always present in RTA link systems. This document presents systems and methods for configuring RTA link systems to mitigate the effects of Rayleigh backscattering.

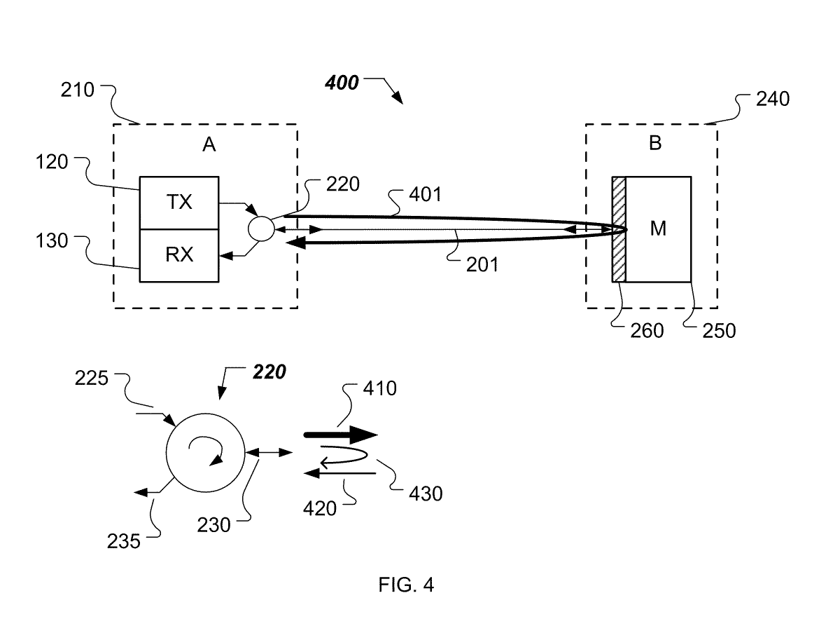

The RTA link system 400 shown in FIG. 4 is used to quantify the effect of the Rayleigh backscattering noise at the input-output port 230 of station A 210. For example, a CW carrier signal 401 having an initial power level denoted I₀ is emitted by station A 210. The initial power level I₀ is depicted in the inset of FIG. 4 by a thick arrow 410 pointing away from the input-output port 230. The carrier signal 401 is transmitted through the transmission line 201 to station B 240. The distance from station A 210 to station B 240 is denoted D. A loss fraction is denoted L and corresponds to the fraction of the initial carrier signal power I₀ transmitted over the distance D. For example, a small L<<1 corresponds to a small fraction of the initial carrier signal power being transmitted over the distance D. In contrast, a large L<=1 (less then but almost equal to 1) corresponds to a large fraction of the initial carrier signal power being transmitted over the distance D. Additionally, in optical fiber transmission lines the loss fraction L is inversely proportional to the distance D traveled through the transmission line. For example, a small fraction L of a signal is transmitted over a large distance D, while a large fraction L of a signal is transmitted over a short distance D.

The carrier signal can be modulated at station B 240 by modulator 250. The modulation amplitude duty cycle fraction is denoted μ. For example, μ=0.5 corresponds to a 50% amplitude modulation duty cycle. A modulation fraction μ=1 corresponds to the case when station B 240 does not modulate the reflected carrier signal or modulates with a constant amplitude scheme like phase modulation. The modulated carrier signal returns to station A 210 through the transmission line 201. The average power of the carrier signal returning to station A 210 is given by

<Iₛ>=μI₀L² (2)

The initial signal power I₀ is multiplied twice by L, once for each of the two trips traveled from station A 210 to station B 240 and back to station A 210. The fraction μ accounts for the reduction of signal power due to the presence of modulation. Note that in EQ. 2 the losses are accounted for in multiplicative manner. The power of the carrier signal returning to station A 210 is depicted in the inset of FIG. 4 by a thin arrow 420 pointing towards the input-output port 230. The average power of the carrier signal returning to station A, given by EQ. 2, represents the numerator of the OSNR formula in EQ. 1.

The reason for choosing the OSNR as the metric for assessing the system impact of co-propagating optical noise sources like Rayleigh backscattering is discussed below. Other noise sources of an electrical origin, for example receiver thermal noise, are added to the receiver noise in a manner that is independent of the received optical signal. Therefore, in the case of thermal noise, the signal-to-noise ratio at the receiver can be increased by increasing the optical power emitted at the source or by amplifying the transmitting optical signal. However, noise sources that are actually created by the optical signal itself, like Rayleigh backscattering noise, cannot be handled independently of the optical signal. In the case of Rayleigh backscattering noise, increasing or attenuating the optical signal power increases, respectively attenuates, the level of backscatter by the same fraction, and hence leaves the OSNR unaffected. Therefore, the limiting OSNR of Rayleigh backscattering can always be evaluated for an optical signal propagating in an RTA system by measuring the OSNR at the point where the leading edge of the optical signal passes it own trailing edge.

For example, for an RTA system which has no amplifiers, the leading edge of the signal by definition experiences the maximum path attenuation and the trailing edge by definition has the minimum attenuation. Since the configuration of an RTA system is such that the leading edge of a signal is able to encounter its own trailing edge in the same fiber, then this encounter determines the limiting OSNR (assuming no other optical noise source dominates). In the case of a CW signal in an RTA link system 400, the leading edge of a signal encounters its own trailing edge at the point where the reflected signal returns to the receiver. In an RTA link system 400, this represents the point in the system where the signal is at its lowest level due to fiber attenuation, and the Rayleigh backscattering noise is at its highest level being generated by the signal which has just been emitted. It is shown in the next section that for signal packets in RTA link systems, the leading edge of the signal encounters its own trailing edge at different points along the fiber, away from station A 210, depending on the duration of the signal packet.

Returning to the RTA link system 400 in FIG. 4, the carrier signal reflected at station B 240 is limited by its own Rayleigh backscatter. The carrier signal after reflection will combine with the backscatter from the portion of the carrier signal still propagating towards station B. Therefore, the Rayleigh backscattering noise in the transmission line 201 is significant at points on the transmission line 201 where the leading end of the carrier signal catches up with the trailing end of the carrier signal after reflection at station B 240. For a CW carrier signal 401 in the RTA link system 400, the largest Rayleigh backscattering noise occurs at the input-output port 230 of station A 210. The power of the Rayleigh backscattering noise is denoted b. The strength of the Rayleigh backscatter is expressed in terms of a fraction denoted S_{R}. Therefore the average power of the Rayleigh backscattering noise detected at the input-output port 230 of station A 210 is expressed as

<I_{B}>=S_{R}I₀. (3)

The fraction S_{R} depends on the material properties of the transmission line 201 and is independent of location on the transmission line (distance from station A 210). The average power of the Rayleigh backscattering noise detected at the input-output port 230 of station A 210 is depicted in the inset of FIG. 4 by a reverse-C shaped arrow 430 pointing towards the input-output port 230. The quantity given by EQ. 3 represents the denominator of the OSNR formula in EQ. 1.

By combining equations (1)-(3), the OSNR at the input-output port 230 of station A 210 is given by

$$OSNR = \frac{〈 {I}_{S} 〉}{〈 {I}_{B } 〉} = \frac{μ {I}_{0} {L}^{2}}{{S}_{R} {L}_{0}} = \frac{{L}^{2}}{2 {S}_{R}} . \qquad ( 4 )$$

In this example, the modulation fraction in EQ. 4 is 0.5 corresponding to a 50% modulation duty cycle.

EQ. 4 predicts that in the RTA link system 400 the OSNR at the input-output port 230 of station A 210 is small. A large Rayeigh backscattering noise contribution 430 is contained in the denominator of the OSNR. The Rayleigh backscattering noise 430 is large because the Rayleigh backscattering occurs at station A 210 where the carrier signal power 410 is largest (see EQ. 3). The power contributed by the returning carrier signal 420 to the numerator of OSNR is small. The power of the carrier signal returning 420 to station A is low because the carrier signal undergoes losses during the round trip from station A to station B. Hence the OSNR at the input-output port 230 of station A 210 for the RTA link system 400 is determined by the lowest signal to highest noise level.

The following sections of this document present RTA systems and techniques to mitigate the effects of Rayleigh backscattering. The OSNR in EQ. 4 can be increased, on one hand, by increasing the carrier signal power in the numerator, on the other hand, by decreasing the power of the Rayleigh backscattering noise power in the numerator. The first approach includes finding RTA link configurations for which the effective propagation length of the carrier signal is short (see EQ. 2). The second approach includes finding RTA link configurations for which the power level of the transmitted signal is small at the location where the Rayleigh backscattering noise occurs (see EQ. 3).

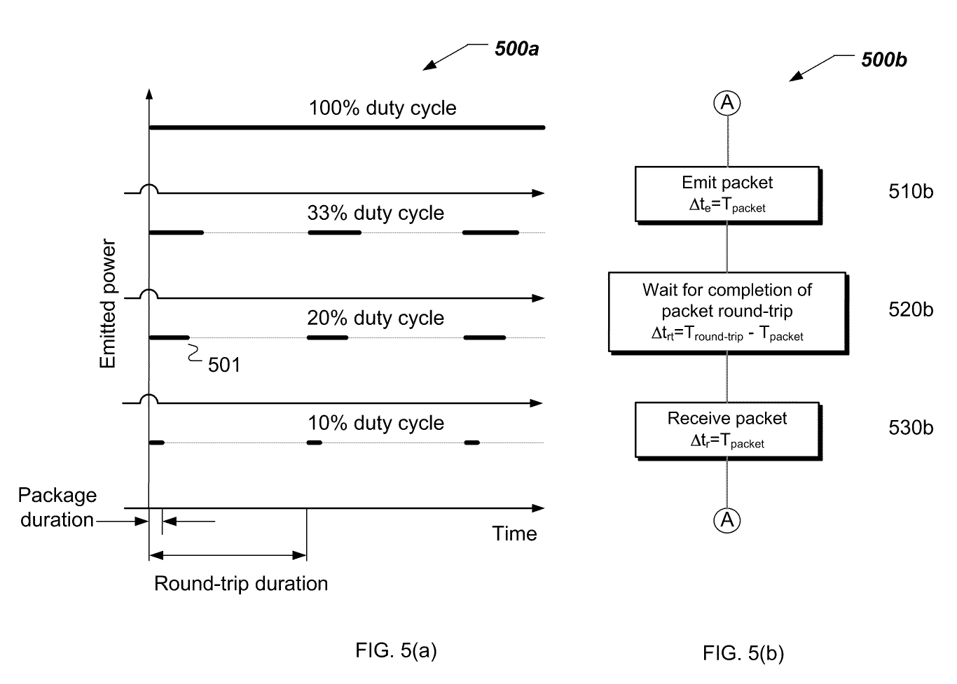

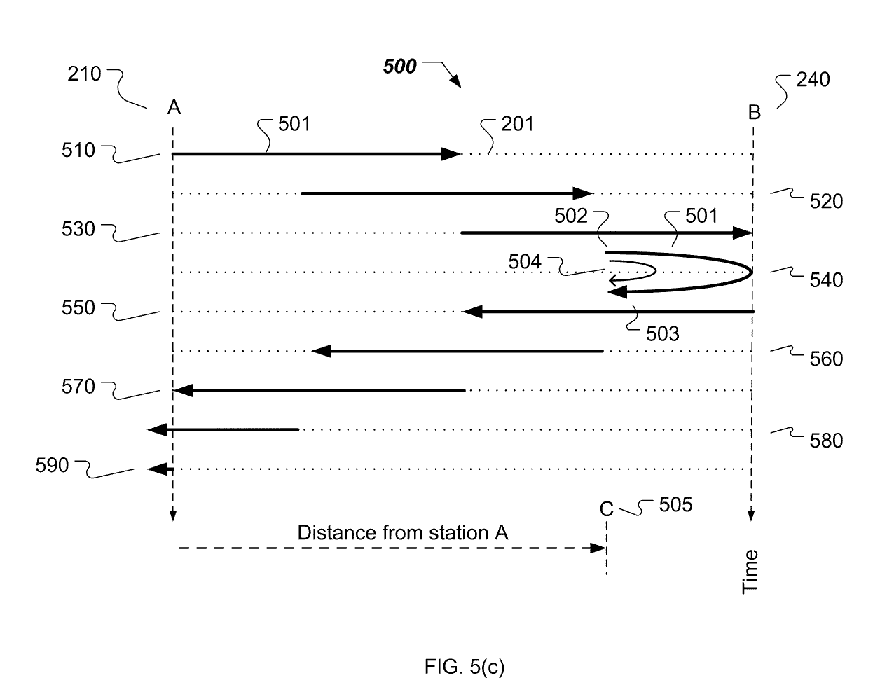

As discussed above, the Rayleigh backscattering noise is largest (limiting) at a location on the transmission line where the leading end of the carrier signal catches up with the trailing end of the carrier signal after reflection by station B 240. For example, for a CW carrier signal in the RTA link system 400 the Rayleigh backscattering noise is largest at the input-output port 230 of station A 210. In another implementation discussed below in reference to FIG. 5(c), the limiting Rayleigh backscattering noise of the RTA link system can be calculated at a point, say C, away from station A 210. Thus, at point C the leading end of the carrier signal catches up with the trailing end of the carrier signal after reflection by station B 240. The power remaining in the carrier signal after propagation from station A 210 to point C is less that the initial carrier signal power I₀ at station A 210. Therefore according to EQ. 3, the Rayleigh backscattering noise at point C, away from station A 210, is less than the Rayleigh backscattering noise at station A 210 for a CW carrier signal in the RTA link system 400. Note that a small Rayleigh backscattering noise term in the OSNR denominator determines a large OSNR. Additionally, the signal is also larger at point C than it would be at the end of the return path at station A 210. Therefore the contribution to the OSNR numerator is also larger at point C than at station A 210. These combined benefits result in an increased OSNR.

To enable the leading end of the carrier signal to catch up with the trailing end of the carrier signal after reflection at station B 240 at a point C, away from station A 210, a packet signal can be emitted that has a duration shorter than the time taken by the carrier signal for a round trip from station A 210 to station B 240:

T_{packet}≦T_{RoundTrip}. (6)

The reasoning presented above suggests that the OSNR of the RTA link system 400 can be increased if the TX 120 of station A 210 emits packets of carrier signal instead of a CW carrier signal 410 as in the previous implementation of the RTA link system 400.

FIG. 5(a) illustrates several duty cycles 500a for packet emission by the TX 120 of station A 210. The duty cycle for packet emission is defined as the fraction of packet duration to the round trip duration. For example, a 20% emission duty cycle 501 corresponds to signal carrier emission for a time T_{packet} that is five times shorter that the round-trip duration T_{round-trip}. The inequality in EQ. 6 corresponds to emission duty cycles less than 100%, while the equality corresponds to the CW carrier signal in the RTA link system 400.

FIG. 5(b) presents a method 500b of packet emission and reception by station A 210. The TX 120 emits 510b a carrier signal packet for a duration of time T_{packet}. The emission is then stopped and station A waits 520b for the carrier signal packet to propagate from station A 210 to station B 240 and back to station A 210. The propagation occurs through the transmission line 201 over a duration of time T_{round-trip}. After waiting for a time Δtᵣₜ=T_{round-trip}−T_{packet} (necessary for the leading edge of the packet to return to station A 210) the RX 130 receives 530b the returning carrier signal packet. The signal reception by RX 130 lasts for a duration of time T_{packet}. Once the entire packet is received by RX 130, the cycle 500b is repeated starting with step 510b.

If the emission duty cycle of method 500b is less than 100% (or T_{packet}<T_{round-trip}) then the Rayleigh backscattering noise is largest (limiting) at a point C away from station A 210, because, the leading end of the carrier signal packet catches up with the trailing end of the carrier signal packet at point C after reflection by station B 240. The smaller the emission duty cycle, or equivalently the shorter the packet, the farther away point C is from station A.

The propagation of a carrier signal packet 501 through the RTA link system 400 is illustrated in FIG. 5(c). The signal packet 501 is generated at station A 210 based on a 20% emission duty cycle schedule presented in FIG. 5(a). FIG. 5(c) illustrates a swim-lane diagram 500. The location of station A 210 is represented as the left lane of diagram 500. The location of station B 240 is represented as the right lane of diagram 500. The center lane of diagram 500 corresponds to the transmission line 201. The time axis of diagram 500 is oriented from top to bottom. Each horizontal level of diagram 500 represent a time instance (time slice) of a transmission process. At time 510 station A 210 completes the emission of a carrier signal packet 501 for transmission to station B 240. The TX 120 is inactive during the time duration from 510 to 590. The time instance 520 illustrates the carrier signal packet 501 traveling towards station B 240 through the transmission line 201. At time instance 530 the leading edge of the carrier signal packet 501 reaches station B 240. During the time interval from 530 to 550 the carrier signal packet 501 is being reflected by station B 240. The leading end of the carrier signal packet catches up with the trailing end of the carrier signal at time instance 540. This event occurs at point C 505. Point C 505 is located a distance Dc from station A. Distance Dc is a fraction α of the distance D between station A 210 and station B 240.

D_{C}=αD. (7)

The time instance 560 illustrates the carrier signal packet 501 traveling towards station A 210 through the transmission line 201. At time instance 570, the leading edge of the returning carrier signal packet 501 reaches station A 240. Between times 570 and 590 the RX 130 is active and receives the returning packet 501. At time instance 590 the RX 130 stops receiving and the TX 120 is ready to emit the next carrier signal packet.

The OSNR for carrier signal packet transmission can be calculated in reference to the time instance 540. In accordance to EQ. 2, the average signal power returning to point C 505 after reflection from station B 240 is given by

<Iₛ(α)>=I₀LL^{1-α} (8)

The first factor L corresponds to losses that the packet incurs from station A 210 to station B 240. The second factor L^{1-α} corresponds to losses that the reflected packet incurs from station B 240 to point C 505.

In accordance to EQ. 3, the average noise power due to Rayleigh backscattering at point C 505 is given by

<I_{B}(α)>=S_{R}I₀L^{α} (9)

Note that the trailing edge of packet 501 travels from station A 210 to point C 505 over a distance αD. Therefore the Rayleigh backscattering noise contribution at point C 505 is smaller by a factor L^{α} compared to the Rayleigh backscattering noise contribution at the input-output port 230 of station A 210 (given by EQ. 3).

Thus, the OSNR calculated at point C 505 is given by

$$OSNR ( α ) = \frac{〈 {I}_{s} ( α ) 〉}{〈 {I}_{B} ( α ) 〉} = \frac{{I}_{0} {LL}^{1 - α}}{{S}_{R} {I}_{0} {L}^{α}} = \frac{{L}^{2 ( I - α )}}{{S}_{R}} , \qquad ( 10 )$$

In EQ. 10 α is the fraction of the physical distance between station A 210 and point C 505 and the length of the RTA link system 400. When no modulation is applied at station B 240 of the RTA link system 400, μ=1, the results presented in EQ. 3 and EQ. 10 are equivalent.

EQ. 10 suggests that the OSNR increases as the length of the signal packet shortens (α->0). Equivalently, the carrier signal packet emission duty cycle, shown in FIG. 5(a), can be decreased in order to increase the OSNR of the RTA link system 400. Furthermore, in the limit when α=1, when the signal packet is very short (very small emission duty cycle), EQ. 10 predicts an upper bound for OSNR(α=1)=1/S_{R}. In this limiting case, when the length of the signal packet is at least equal to the Rayleigh distance (approx. 20 km in optical fiber), a small but finite (i.e. S_{R}≠0) Rayleigh backscattering noise can be measured.

It was shown above in regard to FIGS. 5(a)-(c) that the OSNR of the RTA link system 400 can be increased by reducing the duty cycle of carrier signal emission. While causing an increase in the OSNR, as shown in EQ 10, the reduction in duty cycle of the carrier signal emission causes a reduction in the communication capacity for an RTA link since the data is only being transmitted for a short fraction of time. For example, carrier signal emission at 33% or 10% duty cycle reduces the RTA link capacity by a factor of three or ten. The methods and systems disclosed in the remainder of this document enable full recovery of the RTA link capacity while preserving the large OSNR obtained through emission of carrier signal packets. The methods and systems described below restore the 100% duty cycle of carrier signal emission without decreasing the enhanced OSNR obtained through packet emission.

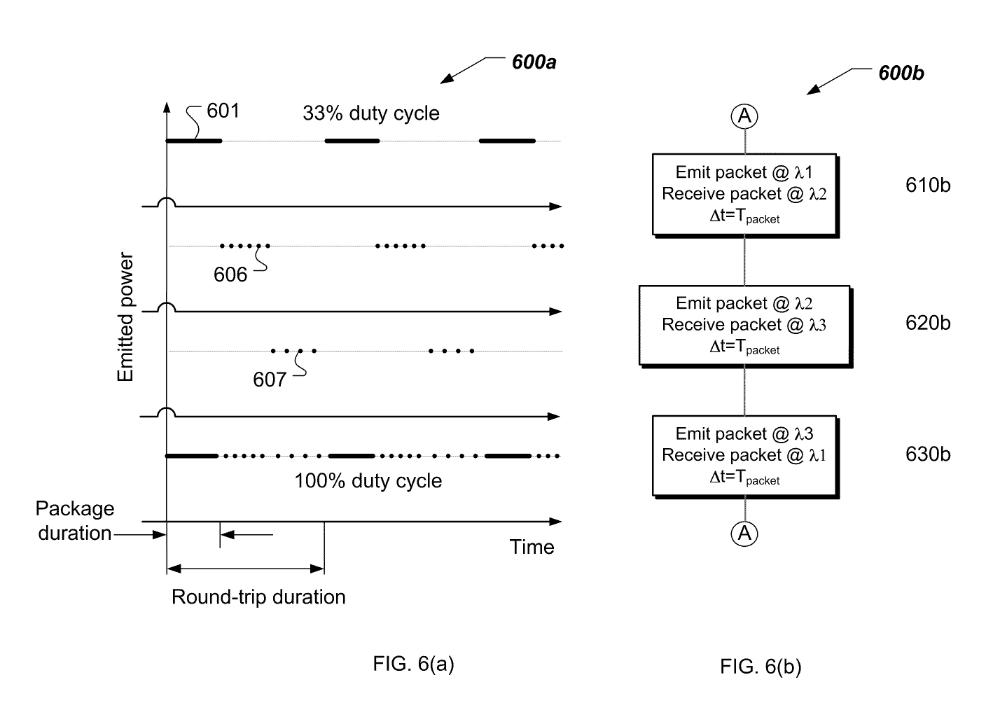

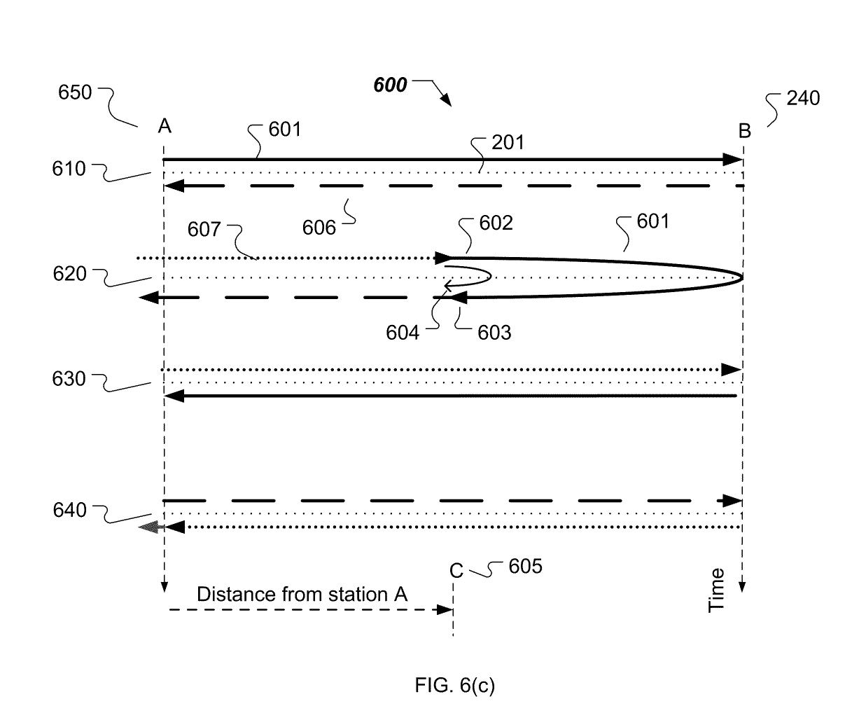

FIG. 6(a) illustrates an exemplary implementation of a 100% duty cycle emission schedule configured as a combination of three 33% emission duty cycle signals 601, 606 and 607. Note that for RTA links the emission duty cycle is defined as the packet duration over the round-trip duration. The packets 601, 606 and 607 are emitted successively such that the three signals 601, 606 and 607 are successively delayed by a third of the total round-trip period. The 100% duty cycle of the combination emission schedule recovers the full capacity of the RTA link. While a 100% duty cycle is desirable to maintain the capacity of the RTA link, it is important to preserve the separation of the three packets. If the three packets merge into one packet that covers the entire round-trip duration (for a 100% emission duty cycle), then the CW carrier signal in the previous implementation of the RTA link system 400 is recovered. It was shown in regard to EQ. 4 that the CW carrier signal configuration of the RTA link has the lowest OSNR.

Therefore the three packets 601, 606 and 607 combined in the 100% duty cycle emission schedule must remain distinct to benefit from the increased OSNR shown in EQ. 10 by ensuring that the Rayleigh backscatter from one packet cannot interfere with the signal from any other packet. The distinction between the three packets 601, 606 and 607 can be achieved by providing the packets at different wavelengths. Different color packets can be used in an RTA link because the color of Rayleigh backscattered light remains the same as the color of the original light. Therefore Rayleigh backscattering noise of a certain color can only mix with carrier signal packet of the same color.

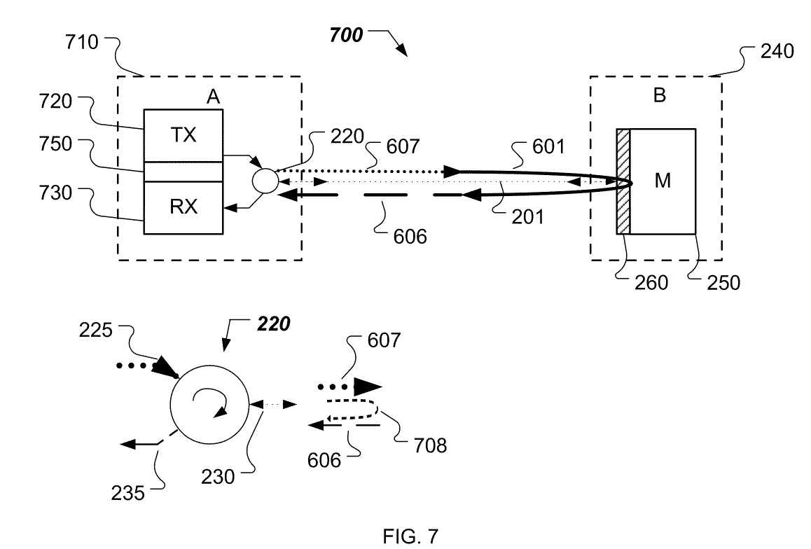

Operation of an RTA link system based on three carrier signals of different wavelengths each having a 33% emission duty cycle is given by FIG. 6(b). System implementations of the RTA link system based on method 600b are presented in regard to FIGS. 7-9. The method 600b starts with step 610b during which a packet of wavelength λ1 is emitted at station A of the RTA link system. At the same time a packet of wavelength λ2 is received at station A. The first step 610b, and each of the subsequent steps lasts for a time equal to the duration of a packet. The packet duration for the 33% emission duty cycle carrier signals 601, 606 and 607 is a third of the round trip duration. During step 620 a packet of wavelength λ2 is emitted at station A, and a packet of wavelength λ3 is received at station A. In the last step 630b a packet of wavelength λ3 is emitted at station A, and a packet of wavelength λ1 is received at station A.

The propagation of three carrier signals 601, 606 and 607 through an exemplary RTA link system 600c is illustrated in FIG. 6(c). The signal packets 601, 606 and 607 are generated at station A 650 based on the 33% emission duty cycle schedule presented in FIG. 6(a). FIG. 6(c) illustrates a swim-lane diagram 600. The location of station A 650 is represented as the left lane of diagram 600. The location of station B 240 is represented as the right lane of diagram 600. The center lane of diagram 600 corresponds to the transmission line 201. The time axis of diagram 600 is oriented from top to bottom. Each horizontal level of diagram 600 represent a time instance (time slice) of a transmission process.

At time 610 station A 650 completes the emission of a carrier signal packet 601 of wavelength λ1 for transmission to station B 240. While the trailing end of the carrier signal packet 601 leaves station A 650, the leading end of the carrier signal packet 601 reaches station B 240. The carrier signal packet 606 of wavelength λ3 returns back to station A 650 after being reflected by station B 240. While the trailing end of the carrier signal packet 606 leaves station B 240, the leading end of the carrier signal packet 606 reaches station A 650. At this time 610, station A 650 also completes the reception of carrier signal packet 607 of wavelength λ2.

The time instance 620 illustrates the carrier signal packet 601 being reflected by station B 240. Station A 650 emits the carrier signal packet 607 of wavelength λ2 for transmission to station B 240. Station A 650 receives the carrier signal packet 606 of wavelength λ3.

At time 630 station A 650 completes the emission of a carrier signal packet 607 of wavelength λ2. While the trailing end of the carrier signal packet 607 leaves station A 650, the leading end of the carrier signal packet 607 reaches station B 240. The carrier signal packet 601 of wavelength λ1 returns back to station A 650 after being reflected by station B 240. While the trailing end of the carrier signal packet 601 leaves station B 240, the leading end of the carrier signal packet 601 reaches station A 650. At this time 630, station A 650 also completes the reception of carrier signal packet 606 of wavelength λ3.

At time 640 station A 650 completes the emission of a carrier signal packet 606 of wavelength λ3. While the trailing end of the carrier signal packet 606 leaves station A 650, the leading end of the carrier signal packet 606 reaches station B 240. The carrier signal packet 607 of wavelength λ2 returns back to station A 650 after being reflected by station B 240. While the trailing end of the carrier signal packet 607 leaves station B 240, the leading end of the carrier signal packet 607 reaches station A 650. At this time 640, station A 650 also completes the reception of carrier signal packet 601 of wavelength λ1.

Returning to time 620 of diagram 600, the leading end 603 of the carrier signal packet 601 catches up with the trailing end 602 of the carrier signal packet 601 at a location C 605. As shown in the previous sections, the Rayleigh backscattering noise 604 is limiting at point C 605. Furthermore, point C 605 is situated midway between station A 650 and station B 240 for the RTA link system 600 based on three 33% emission duty cycle carrier signals of different colors. The midpoint C 605 corresponds to α=0.5 in EQ. 7. By substituting α=0.5 in EQ. 10, the OSNR estimated at the mid-point between stations A 650 and B 240 is given by

$$OSNR ( α = 0.5 ) = \frac{L}{S} \qquad ( 11 )$$

The OSNR calculated in EQ. 11 for the RTA link system 600 based on three 33% emission duty cycle carrier signals of different colors is larger than the OSNR calculated in EQ. (4) for the RTA link system 400 based on the CW signal carrier. An increase in OSNR between the RTA link systems 600 and 400 has been achieved while both RTA link configurations have an emission duty cycle of 100%. Thus, a three-wavelength gated RTA link system 600 has a larger OSNR for an identical link capacity than the RTA link system 400 based on CW signal carrier emission.

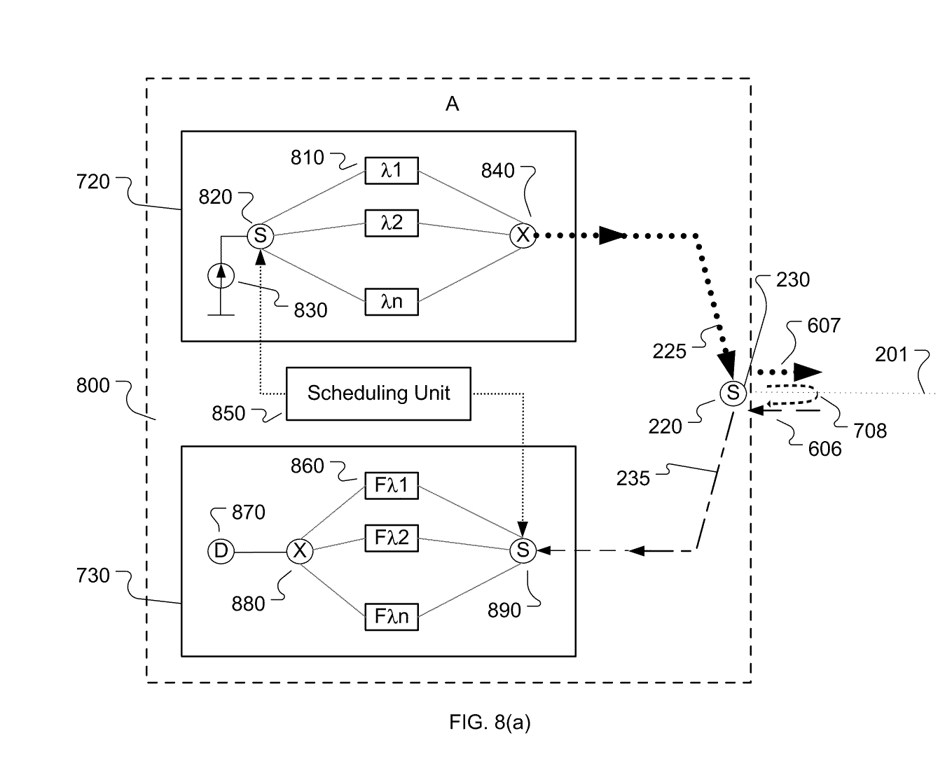

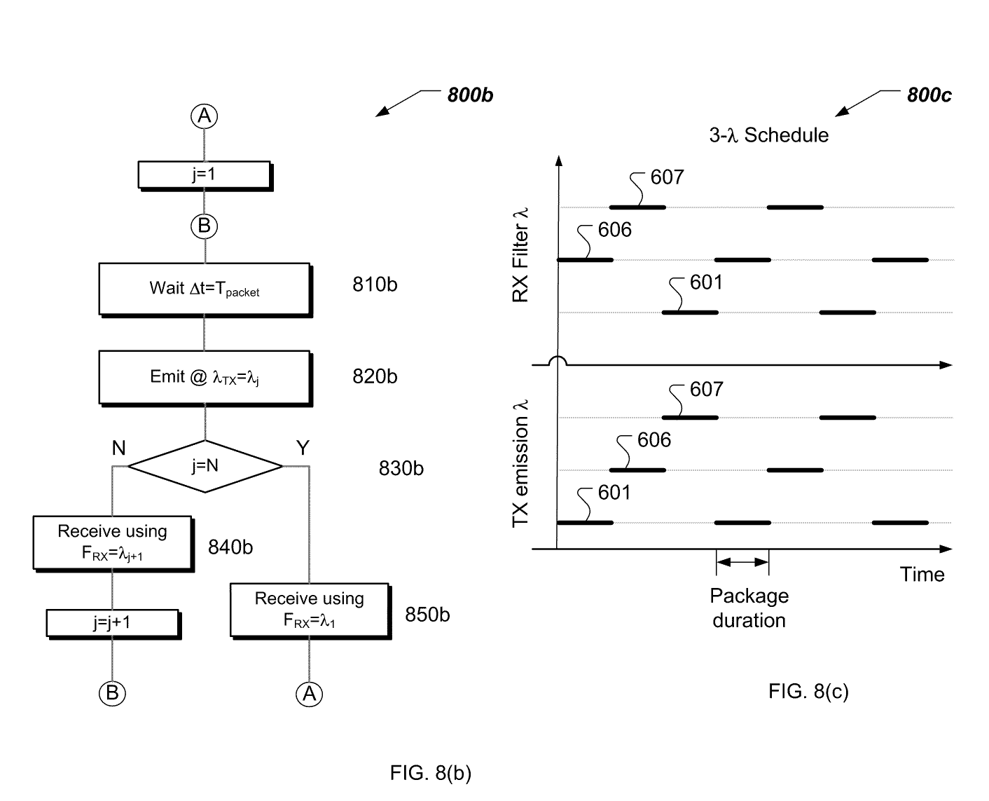

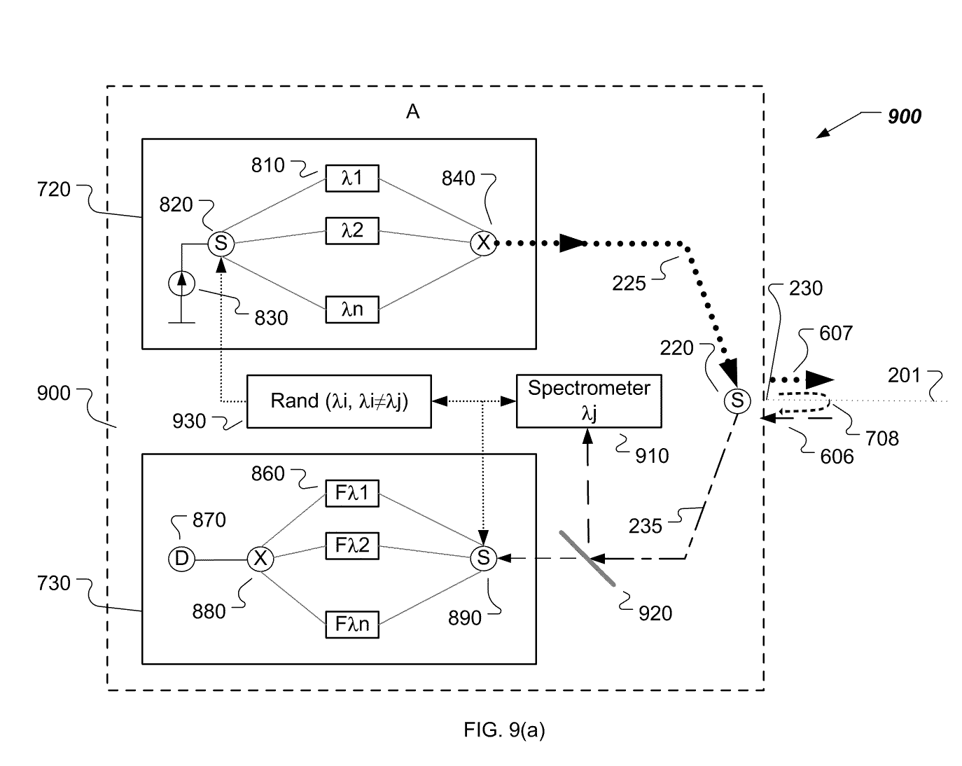

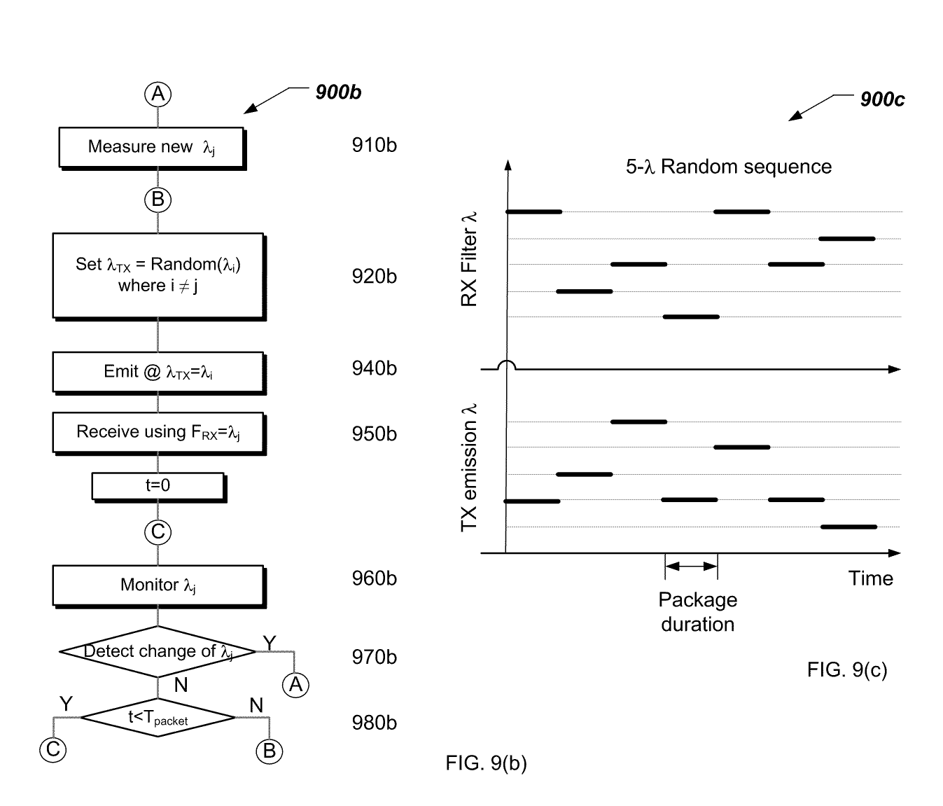

The system implementation of the RTA link described above is illustrated schematically in FIG. 7. The RTA link system 700 contains a station A 710 that communication with station B 240 through a transmission line 201. Station B 240 can be the same node described in FIG. 2 or 4. Station A 710 includes a transmitter TX 720, a receiver RX 730, a scheduling unit 750 and an optical coupler 220. The TX 720 is configured to emit the signal carrier in packets. Moreover, each signal carrier packet can be emitted at a different wavelength based on appropriate emission schedules. Implementations of the TX 720 are described in detail with respect to FIGS. 8-9. The RX 730 is configured to receive signal carrier packets of different wavelengths. The reception schedule of RX 730 is synchronized with the emission schedule of TX 720. Implementations of the RX 730 are described in detail with respect to FIGS. 8-9. Operation modes of the combination TX 720 and RX 730 (described in detail later) are controlled by the scheduling unit 750. The optical coupler 220 can be the same three-port element described in FIG. 2 or 4. Port 230 of the optical coupler 220 represents an input-output port of Station A 710.

FIG. 7 also depicts the three signal carrier packets 601, 606 and 607 introduced in FIGS. 6(a)-(c). Specifically, the time instance 620 of diagram 600 is overlaid onto the RTA link system 700 in FIG. 7. The carrier signal packet 601 of wavelength λ1 is reflected by station B 240. The TX 720 emits the carrier signal packet 607 of wavelength λ2 for transmission to station B 240. The RX 730 receives the carrier signal packet 606 of wavelength λ3.

The inset of FIG. 7 illustrates contributions to signal and noise at the input-output port 230 of station A 710. The carrier signal packet 607 of wavelength λ2 is depicted by an arrow 607 pointing away from the input-output port 230. The Rayleigh backscatter noise generated by the carrier signal packet 607 of wavelength λ2 is depicted by a reverse-C shaped arrow 708 pointing towards the input-output port 230. As mentioned above, the color of Rayleigh backscattered noise 708 λ2 is the same as the color of the original carrier signal packet 607. Additionally, the carrier signal packet 606 of wavelength λ3 returning to station A 710 is depicted by an arrow 606 pointing towards the input-output port 230.

The signal and noise contributions at the input-output port 230 of station A 710 (illustrated in the inset of FIG. 7) determine the functionality of the combination TX 720 and RX 730. Specifically, the emission schedule is designed such that a color λ3 of a carrier signal packet 606 returning to station A 710 is different from a color λ2 of a carrier signal packet 607 emitted by station A 710, and implicitly different from the Rayleigh backscattering noise 708 that the emitted packet 607 generates. Additionally, the RX 730 is configured to selectively receive the carrier signal packet 606 of wavelength λ3 returning to station A 710 and at the same time reject the Rayleigh backscattering noise 708 of wavelength λ2 generated by the carrier signal packet 607 being emitted by TX 720.

FIG. 8(a) illustrates schematically a station A 800 configured to address the requirements of the RTA link system 700 enumerated above. The station A 800 includes a transmitter TX 720, a receiver RX 730, a scheduling unit 850 and an optical coupler 220.

The TX 720 is configured to emit carrier signal packets. Moreover, each signal carrier packet can be emitted at a different wavelength λj based on appropriate emission schedules. The TX 720 contains n laser devices 810. The n laser devices 810 are configured to emit carrier signal packets at n different wavelengths. The number of different wavelengths for the RTA link system 700 can be n>=3. The output port 840 of the TX 720 includes a coupler 840 with (n+1) terminals. One terminal is connected to the input 225 of the optical coupler 220 of station A. The other n terminals of the optical coupler 840 connect to the set of n laser devices 810. The n laser devices 810 are connected in parallel to a power supply 830 through a switch 820. The switch 820 is configured to connect the power supply 830 to one laser device 810 at a time. Upon the selection of the emission wavelength 607 λj by the scheduling unit 850, the switch 820 closes the path from the power supply to laser device 810 λj. The carrier signal packet of wavelength 607 λj is emitted by the TX 720 through the port 840. The emitted carrier signal packet 607 exits station A 800 through the optical coupler 220.

The RX 730 is configured to receive signal carrier packets of different wavelengths λi. The reception schedule of RX 730 is synchronized with the emission schedule of TX 720, such that the received wavelength 606 λi is different from the emitted wavelength 607 λj. Therefore the Rayleigh backscattering noise 708 wavelength λj is also different from the received wavelength 606 λi. Both returning carrier signal packet 606 and Rayleigh backscattering noise 708 enter station A through input-output port 230. The carrier signal packets 606 and 708 are directed to the RX 730 through the output 235 of the optical coupler 220 and enter the RX 730 through a port 890.

The RX 730 also includes a detector 870 and n band-pass filters Fλi 860. A band-pass filter Fλi 860 allows light of wavelength λi to pass through the filter and blocks light different from λi. The band-pass filters Fλi 860 correspond to the laser devices 810 in the TX 720. The detector 870 is connected to the n band-pass filters Fλi 860 through a coupler 880 with (n+1) terminals. The n band-pass filters Fλi 860 are connected in parallel to the input port 890 of the RX 730. The input port 890 includes a switch configured to connect the detector to the output port 890 via one band-pass filter Fλi 860 at a time. The switch 890 operates under instructions from the scheduling unit 850. Upon the selection of the receiving wavelength 606 λi by the scheduling unit 850, the switch 890 at the input port opens the path to detector 870 through the band-pass filter Fλi 860. Both carrier signal packet of wavelength 606 λi and the Rayleigh scattering noise 708 are received by the RX 730 through the port 890. The received carrier signal packet 606 is routed to the detector through the band-pass filter Fλi 860 corresponding to 606. In contrast, the Rayleigh scattering noise 708 is blocked by the band-pass filter Fλi 860 corresponding to 606.

In another exemplary implementation, the n band-pass filters Fλi 860 can be replaced by a bandpass optical filter continuously tunable in a spectral range corresponding to the emission range of the n laser devices 810. The continuously tunable bandpass optical filter is operable to pass only a wavelength of the carrier signal packet 606 returning to station A, and reject signals of other colors, including the Rayleigh scattering noise 708.

Returning to station A 800 illustrated in FIG. 8, the scheduling unit 850 controls operations of station A and implicitly of the RTA link system 700. The scheduling unit 850 is in communication with the switch 820 inside the TX 720 to select the emission wavelength. The scheduling unit 850 is also in communication with the switch 890 inside the RX 730 to select the reception wavelength. The scheduling unit 850 is responsible for the emission and reception schedules. The schedules include among other things, packet duration, sequence of colors for emission, synchronization between packet departure and arrival times, etc.

An exemplary method 800b to operate station 800 in the RTA link system 700 is presented in FIG. 8(b). For example, the scheduling unit 850 uses the emission sequence λ1, λ2, λ3, . . . , λn, and the reception sequence λn, λ1, λ2, . . . , λn−1. This exemplary schedule satisfies the rule (established earlier) that the received color is always different than the emitted color.

Step 810 establishes the time duration of the signal carrier packet. The time duration of the signal carrier packet can be calculated as

$${T}_{packet} = \frac{2 D}{( n - 1 ) v} \qquad ( 12 )$$

In EQ. 12, D is the known length of the RTA link system, v is the speed of light in the fiber line, and n is the number of available emission wavelengths. Thus, n packets can maintain a 100% emission duty cycle for the RTA link system 700.

Emission of a carrier signal packet of wavelength λj starts at step 820b. The laser device 810 which emits λj is activated by the switch 820. The looping step 830b verifies if all n available wavelengths have been cycled. In step 840b or 850b detection of the incoming carrier signal packet starts upon selection of the λj+1 band-pass filter Fλj as prescribed in the schedule presented above. The method 800b is then repeated by emitting and receiving the next pair of carrier signal packets, (λj+1, λj+2). And so on.

The schedule described by method 800b is illustrated graphically in FIG. 8(c) for n=3. The emission schedule shown in the bottom graph of FIG. 8(c) is transmitted to the TX 720 by the scheduling unit 850. The reception schedule shown in the top graph of FIG. 8(c) is transmitted to the RX 730 by the scheduling unit 850. In this implementation, the circular permutation of 601, 606 and 607 wavelength sequence may be used for the entire duration of the RTA link system 700 transmission.

The schedule generated by method 800b is based on n wavelengths emitted by the n laser devices 810. For method 800b the order in which the colors are being emitted is unrestricted, albeit once selected, the emission sequence is fixed. Therefore, in one exemplary implementation the preset emission color sequence can be chosen in order of increasing wavelength: λi<λi+1< . . . <λn. When this exemplary sequence reaches the longest wavelengths in the sequence, the sequential emission continues in order of increasing wavelength starting with the shortest available emission wavelength: λ1<λ2< . . . , etc. In another exemplary implementation, the preset emission sequence represents a continuous spectrum, scanned from λmin to λmax. Alternately, in yet another exemplary implementation the preset emission color sequence can be chosen in order of decreasing wavelength: λi>λi−1> . . . >λ1. When this exemplary sequence reaches the shortest wavelength in sequence, the sequential emission continues in order of decreasing wavelength starting with the longest available emission wavelength: λn>λn−1> . . . , etc. In another exemplary implementation, the preset emission sequence represents a continuous spectrum, scanned from λmax to λmin.

The preset emission sequence in the form of a continuous spectrum as described above can be implemented, for example, by replacing the set of n discrete laser devices 810 with a continuously tunable laser device operable to emit one wavelength at a time. The continuously tunable emission range of such a tunable laser may be as wide as the spectral range of the combination of n discrete laser devices 810.

In one implementation n substantially different wavelengths (from a discrete color set or from a continuous spectrum) may be chosen from the 1550 nm telecommunication band. In another implementation the n substantially different wavelengths (from a discrete color set or from a continuous spectrum) may be chosen from the 1310 nm telecommunication band. Yet in another implementation the three substantially different (discrete) wavelengths may belong to two or even three different bands.

A sequential schedule 800c can be implemented for any number n of available wavelengths larger than three. A sequential schedule 800c can be implemented once the properties of the RTA link system 700 are known. For example, the scheduling unit 850 establishes the pulse duration (see EQ. 12) based on n, the number of available emission colors, and D, the length of the RTA link system 700. While n is a known quantity at station A 800, D also needs to be known at station A or otherwise determined. Furthermore, once the sequence has been established, the schedule 800c is carefully enforced.

FIG. 9(a) illustrates schematically a station A 900 that can operate based on a flexible emission schedule. The Station A 900 includes a transmitter TX 720, a receiver RX 730, and an optical coupler 220. The scheduling unit 850 in station A 800 is replaced in station A 900 by three elements. A signal tap 920, a spectrometer 910, and a randomizer 930. The randomizer 930 picks the emission wavelength λi based on information received from the spectrometer, as shown below.

The signal tap 920 includes a beam splitter that directs a small fraction of the carrier signal packet 606 returning to station A 900 and the Rayleigh backscattering noise 708 to a spectrometer 910. The spectrometer 910 measures the wavelengths λj of the carrier signal packet 606 and λk of the Rayleigh backscattering noise 708. The randomizer 930 informs the spectrometer 910 of the current emission wavelength λi. The Rayleigh backscattering noise 708 originates from the emitted carrier signal packet 607, therefore the colors of the Rayleigh backscattering noise 708 and emitted carrier signal packet 607 are identical, λk=λi. Thus, the spectrometer 910 can discriminate between the two measured wavelengths λj and λk. The spectrometer instructs the RX 730 via the switch 890 to select the band-pass filter Fλi 860 corresponding to the identified returning carrier signal packet 606. Furthermore, the spectrometer 910 also informs the randomizer 930 of the color of the newly received carrier signal packet 606. Upon notification from the spectrometer 910 that the next carrier signal packet of wavelength λm arrives at station A 900, the randomizer 930 changes the emission wavelength λi again.

An exemplary method 900b to operate station A 900 is presented in FIG. 9(b). The method 900b starts at step 910b where the spectrometer 910 measures the wavelength λj of a newly returning packet 606. The randomizer 930 randomly selects a new emission wavelength λi at step 920b. Since the detected wavelength λj has been identified, the set of available random emission wavelengths excludes the color just detected. At step 940b the TX 720 emits a carrier signal packet 607 at the newly selected emission wavelength λi. The RX 730 uses the band-pass filter Fλj 860 to receive 950b only the returning carrier signal packet 606 and to reject the Rayleigh backscattering noise 708.

During the duration of a packet, the spectrometer 910 monitors 960b the wavelength λj of the returning carrier signal packet 606. During conditional step 980b, upon detection of a change in the wavelength λj of the returning carrier signal packet 606, the method returns to first step 910b. The next emission color is selected randomly during step 920b, and on and on.

A random sequence using five wavelengths generated based on method 900b is presented graphically in FIG. 9(c). Note that the duty cycle for emission is 100% as in the case of method 800b. Because the method 800b is based on a fixed sequence schedule, the pulse duration is related to the round-trip duration (see EQ. 11). In contrast, for method 900b based on a random sequence schedule, the pulse duration can be chosen independently from the length of the RTA link and round-trip duration.

Additionally, it was shown regarding EQ. 10 that RTA links based on short carrier signal packets are characterized by large OSNR. To maintain 100% emission duty cycle when the TX 720 emits short carrier signal packets, a large number n of emission colors is used. If a only a small number n of emission colors is available but a short packet duration is desired for the RTA link system 700, then the random method 900 can be used.

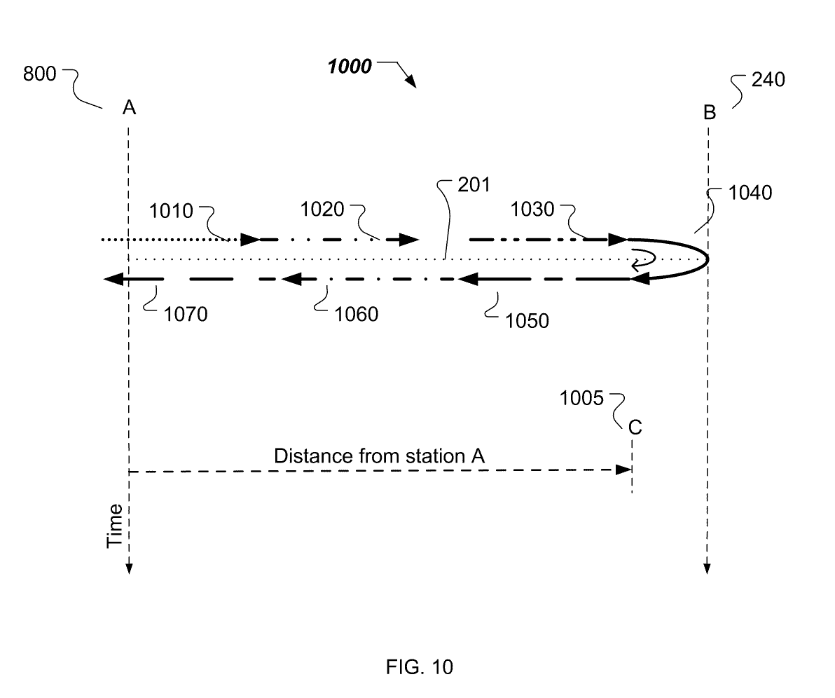

FIG. 10 illustrates the propagation of (n−1) carrier signals packets 1010, 1020, . . . , 1070, for a total of n colors, through an exemplary RTA link system 1000. The extra color is in addition to the (n−1) number of propagating carrier signal packets of different colors, such that station A 800 can emit a carrier signal packet of a different color from the color of a carrier signal packet returning to station A 800. The carrier signal packets are generated at station A 800 based on a 1/(n−1) (%) propagation duty cycle and a fixed emission sequence, as described in method 800b. FIG. 10 illustrates a swim-lane diagram 1000. The location of station A 800 is represented as the left lane of diagram 1000. The location of station B 240 is represented as the right lane of diagram 1000. The center lane of diagram 1000 corresponds to the transmission line 201. The time axis of diagram 1000 is oriented from top to bottom. One horizontal level is depicted in diagram 1000 representing a time instance (time slice) of a transmission process.

Diagram 1000 shows that station A 800 emits a carrier signal packet 1010 of wavelength λ1 for transmission to station B 240. At the same time station A 800 receives a carrier signal packet 1070 of wavelength λ2. A set of previously emitted carrier signal packets 1020, 1030, . . . travel towards station B 240 through the transmission line 201. Another set of previously emitted carrier signal packets 1050, 1060, . . . travel towards station A 800 through the transmission line 201 after reflection at station B 240.

Diagram 1000 also shows that the leading end of the carrier signal packet 1040 catches up with its trailing end at a location C 1005 after reflection by station B 240. As shown in the previous sections, the Rayleigh backscattering noise is largest at point C 1005. The carrier signal packet reflected by station B 240 is limited by its own Rayleigh backscatter. The signal after reflection will combine with the backscatter from the portion of the signal still propagating towards the reflector. Furthermore, point C 1005 is situated a distance (n−2)/(n−1)D between station A 800 and station B 240 for the RTA link system 1000 based on n carrier signals of different colors. Point C 1005 corresponds to α=(n−2)/(n−1) in EQ. 7. By substituting α=(n−2)/(n−1) in EQ. 10, the OSNR estimated at point C 1005 between stations A and B is approximately given by

$$OSNR ( n ) = \frac{{L}^{\frac{2}{n - 1}}}{S} \qquad ( 12 )$$

The OSNR calculated in EQ. 12 for the RTA link system 1000 based on n carrier signals of different colors increases as n grows larger.

The OSNR calculated in EQ. 12 for the RTA link system 600 based on n=3 carrier signal packets of different colors is larger than the OSNR calculated in EQ. (4) for the RTA link system 400 based on a CW carrier signal.

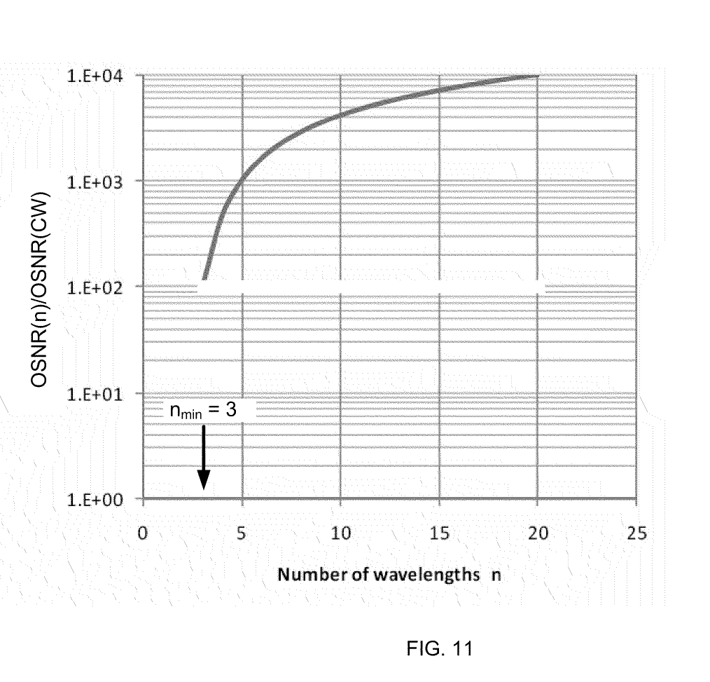

FIG. 11 illustrates the ratio of the OSNR for link 700 based on n carrier signal packets of different wavelengths (per EQ. 12) to the OSNR for link 400 based on CW carrier signal emission (per EQ. 4). The length of the line is set to 100 km. As the number of wavelengths n increases and the carrier signal packet length correspondingly decreases, the OSNR continues to improve as predicted by the analysis preceding EQ. 12.

The ratio in FIG. 11 may eventually saturate for a large number of wavelengths as other noise sources may dominate the OSNR.

Although a few variations have been described in detail above, other modifications are possible. For example, the logic flow depicted in the accompanying figures and described herein do not require the particular order shown, or sequential order, to achieve desirable results.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, variations, enhancements and other implementations can be made based on what is described and illustrated in this document.

What is claimed is what is described and illustrated, including:

1. A system for optical communications, comprising:
a first optical communication module to output a first optical signal;
an optical link optically coupled to the first optical communication module to receive and transmit the first optical signal; and
a second optical communication module optically coupled to the fiber to reflect the first optical signal, without changing an optical wavelength of the reflected light, back into the link towards the first optical communication module as a second optical signal to be received by the first optical communication module,
wherein the first optical communication module controls a wavelength of the first optical signal to change over time into, at a minimum, a first optical wavelength during a first duration of transmission of the first optical signal and a second, different optical wavelength during a second subsequent duration of the transmission of the first optical signal so that light being received in the second optical signal at the first optical communication module is at the first optical wavelength while light in the first optical signal being output by the first optical communication module is at the second optical wavelength.

2. The system as in claim 1, wherein:
the second optical communication module comprises an optical modulator that modulates the reflected light in the second optical signal to superimpose information or data onto the second optical signal to transmit the information or data to the first optical communication module.

3. The system as in claim 1, wherein:
the first optical communication module comprises a light source that produces light of, at a minimum, the first optical wavelength and the second optical wavelength.

4. The system as in claim 1, wherein:
the first optical communication module comprises an optical receiver that selects light in the second optical signal at one of, at a minimum, the first and the second optical wavelengths to detect while rejecting light at other wavelengths.

5. The system as in claim 1, wherein:
the first optical communication module comprises an optical transmitter that produces light of, at a minimum, the first optical wavelength and the second optical wavelength, at different times, and an optical receiver that selects light in the second optical signal at one of, at a minimum, the first and the second optical wavelengths to detect while rejecting light at other wavelengths, and
wherein the optical transmitter and the optical receiver synchronize with each other to transmit and receive at different wavelengths at a given time.

6. A system for transmitting a plurality of carrier signal packets from station A to station B and back to station A, the system comprising:
an optical transmission line between station A and station B;
a transceiver coupled at station A, wherein the transceiver comprises:
a transmitter configured to emit the plurality of carrier signal packets for transmission to station B, wherein the plurality of carrier signal packets is emitted at a plurality of different wavelengths based on an emission schedule;
a receiver configured to receive the plurality of carrier signal packets upon return to station A after reflection at station B, wherein the receiver can reject a Rayleigh backscattering noise at an emission wavelength;
a control unit configured to switch the emission wavelength upon receipt of a carrier signal packet at the emission wavelength; and
a reflector coupled at station B to direct the plurality of carrier signal packets back into the optical transmission line for return to station A.

7. The system as in claim 6, wherein the receiver comprises:
a plurality of bandpass optical filters corresponding to the plurality of wavelengths, wherein each bandpass optical filter is selectable to pass only a wavelength of the carrier signal packet returning to station A.

8. The system as in claim 6, wherein the receiver comprises:
a continuously tunable bandpass optical filter in a spectral range corresponding to the plurality of emission wavelengths, wherein the continuously tunable bandpass optical filter is operable to pass only a wavelength of the carrier signal packet returning to station A.

9. The system as in claim 7, wherein the receiver further comprises:
a monitoring module to identify a wavelength of the carrier signal packet returning to station A.

10. The system as in claim 9, wherein the monitoring module comprises:
a beam splitter to extract a portion of the returning carrier signal packet and of the Rayleigh backscattering noise; and
a spectrometer to identify the wavelength of the returning carrier signal packet and of the Rayleigh backscattering noise.

11. The system as in claim 6, wherein the transmitter comprises:
a plurality of laser devices corresponding to the plurality of wavelengths, wherein each laser device is operable to emit one wavelength at a time.

12. The system as in claim 6, wherein the receiver comprises:
a continuously tunable laser device in a spectral range corresponding to the plurality of emission wavelengths, wherein the continuously tunable laser device is operable to emit one wavelength at a time.

13. The system as in claim 6, wherein the control unit operates based on a schedule comprising:
a preset sequence of emission wavelengths synchronized with the sequence of bandpass optical filters.

14. The system as in claim 6, wherein the control unit operates based on a schedule comprising:
a random sequence of emission wavelengths, wherein each emission wavelength is selected to be different from the wavelength of the returning carrier signal packet.

15. A method for transmitting a plurality of carrier signal packets from station A to station B and back to station A, the method comprising:
providing an optical transmission line between station A and station B;
integrating a transmitter coupled at station A capable of emitting a plurality of carrier signal packets at a plurality of different wavelengths;
integrating a receiver coupled at station A capable of selectively detecting the plurality of wavelengths emitted by the transmitter; and
sequentially emitting the plurality of carrier signal packets at the plurality of different wavelengths according to an emission schedule such that a wavelength emitted by the transmitter is different from a wavelength of carrier signal packet detected by the receiver.

16. The method as in claim 15, wherein selectively detecting comprises:
identifying a wavelength of a carrier signal packet returning to station A; and
selecting from a plurality of bandpass optical filters, corresponding to the plurality of wavelengths, the identified wavelength of the carrier signal packet returning to station A.

17. The method as in claim 16, wherein emitting according to the emission schedule comprises:
presetting a sequence of emission wavelengths from the plurality of different wavelengths; and
synchronizing the sequence of bandpass optical filters with the sequence of emission wavelengths.

18. The method as in claim 16, wherein emitting according to the emission schedule comprises:
randomly choosing an emission wavelength from the plurality of wavelengths that is different from the identified wavelength of the carrier signal packet returning to station A.
